(19) United States
(12) Patent Application Publication
(10) Pub. No.: US 2006/0064570 A1
(43) Pub. Date: Mar. 23, 2006

(54) Method and apparatus for automatically generating test data for code testing purposes

(76) Inventor: Luigi Alberto Pio di Savoia, Mountain View, CA (US)

Correspondence Address: A. RICHARD PARK, REG. NO. 41241;PARK, VAUGHAN & FLEMING LLP, 2820 FIFTH STREET, DAVIS, CA, 95616, US

(21) Appl. No.: 10/935,766

(22) Filed: Sep. 7, 2004

(51) Int. Cl. G06F 15/00

(52) U.S. Cl. 712/227

(57) ABSTRACT

One embodiment of the present invention provides a system that automatically generates test data for code testing purposes. During operation, the system receives code under test (CUT). The system then determines type information for one or more parameters for methods of the CUT. Next, the system automatically selects, based on the type information, one or more test data factories (TDFs) to generate test data for parameters of the CUT.

### BACKGROUND

1. Field of the Invention

The present invention relates to techniques for testing software. More specifically, the present invention relates to a method and an apparatus for automatically generating test data for code testing purposes based on generalized test data rules.

2. Related Art

Software testing is a critical part of the software development process. As software is written, it is typically subjected to an extensive battery of tests which ensure that it operates properly. It is far preferable to fix bugs in code modules as they are written, to avoid the cost and frustration of dealing with them during large-scale system tests, or even worse, after software is deployed to end-users.

As software systems grow increasingly larger and more complicated, they are becoming harder to test. The creation of a thorough set of tests is difficult (if not impossible) for complex software modules because the tester has to create test cases to cover all of the possible combinations of input parameters and initial system states that the software module may encounter during operation.

Moreover, the amount of test code required to cover the possible combinations is typically a multiple of the number of instructions in the code under test. For example, a software module with 100 lines of code may require 400 lines of test code to generate test data. At present, this testing code is primarily written manually by software engineers. Consequently, the task of writing this testing code is a time-consuming process, which can greatly increase the cost of developing software, and can significantly delay the release of a software system to end-users.

One of the challenges in testing code is to produce a set of test data that thoroughly exercises the code under test. Unfortunately, creating a thorough set of test data by hand is very tedious and time consuming. Hence, it is desirable to automatically generate test data for code testing. Simple automated test generators, however, have difficulty producing realistic and relevant test data, and tend to generate a large amount of nonsensical test data. Although there are many approaches, methods, and techniques to address various software testing situations, and although there is much undocumented generic and domain-specific testing knowledge developed by software testers, there is currently no way of using this rich reservoir of knowledge to automatically generate test data. Most software developers and testers still approach the task of software testing armed mostly with their intuition and ad-hoc methods, reinventing the wheel every time.

Hence, what is needed is a method and an apparatus for automatically generating realistic, relevant test data using existing testing knowledge.

### SUMMARY

One embodiment of the present invention provides a system that automatically generates test data for code testing purposes. During operation, the system receives code under test (CUT). The system then determines type information for one or more parameters for methods of the CUT. Next, the system automatically selects, based on the type information, one or more test data factories (TDFs) to generate test data for parameters of the CUT.

In a variation of this embodiment, automatically selecting one or more TDFs involves automatically selecting one or more test-data directives (TDDs), wherein a TDD may specify one or more TDFs to be used to generate test data and may specify the manner in which a TDF is used.

In a further variation, automatically selecting the TDDs involves applying a number of generalized test data rules (GTDRs) to the CUT. A GTDR specifies a test data condition (TDC) and specifies one or more TDDs to be used if the CUT satisfies the TDC, wherein a TDC includes at least one predicate. If the CUT satisfies the TDC specified in a GTDR, the system automatically selects the TDD(s) specified by the GTDR.

In a further variation, the system evaluates how frequently a TDD has been selected by a user to generate test data for CUT which satisfies a predicate. If a TDD has been selected by a user sufficiently frequently to generate test data for CUT which satisfies a predicate, the system constructs a GTDR which includes the predicate in a TDC and which specifies the TDD.

In a further variation, evaluating how frequently a TDD has been selected by a user to generate test data for CUT which satisfies a predicate involves computing a user-selection ratio for this predicate-TDD combination, which is the ratio of the number of times a user has selected this TDD to generate test data for CUT which satisfies this predicate, to the number of times CUT satisfies this predicate.

In a further variation, the system obtains a new predicate from CUT, wherein one or more TDDs have been confirmed, selected, or provided by a user for this CUT. The system then computes an updated user-selection ratio for a combination of this predicate and a TDD.

In a further variation, obtaining the predicate from CUT involves applying one or more generic predicates without specific parameters to the CUT to obtain one or more predicates with specific parameters.

In a further variation, the system ranks GTDRs based on the user-selection ratio of the predicate-TDD combination included in each GTDR.

In a further variation, if the user-selection ratio of a predicate-TDD combination falls below a given threshold, the system deletes a corresponding GTDR which includes this predicate and this TDD.

In a variation of this embodiment, the system presents the automatically selected TDFs to a user and allowing the user to choose TDFs from the presented TDFs.

In a further variation, presenting the automatically selected TDFs to the user involves presenting the TDFs on a host which is different from the host where the TDFs reside.

In a variation of this embodiment, the system allows a user to choose TDFs from a set of additional TDFs which are not automatically selected.

In a variation of this embodiment, the system allows a user to provide new TDDs and/or new TDFs.

In a further variation, if the user provides one or more new TDDs and/or TDFs, the system stores the user-provided TDDs and/or TDFs so that these TDDs and/or TDFs may be used for future tests.

### BRIEF DESCRIPTION OF THE FIGURES

FIG. 1 illustrates automatic type association between a piece of code under test and the test data factories in an automated test generator in accordance with an embodiment of the present invention.

FIG. 2 illustrates manual association between a piece of code under test and the test data factories in an automated test generator using a TDF map in accordance with an embodiment of the present invention.

FIG. 3 presents a block diagram illustrating the process of producing generalized test data rules for automatic test data generation in accordance with an embodiment of the present invention.

FIG. 4 presents a flow chart illustrating the process of automatically generating test data for a piece of code under test in accordance with an embodiment of the present invention.

Table 1 illustrates an exemplary TDF interface in accordance with an embodiment of the present invention.

Table 2 illustrates an exemplary TDF that produces an empty string in accordance with an embodiment of the present invention.

Table 3 illustrates an exemplary TDF that generates String objects representing phone numbers in accordance with an embodiment of the present invention.

Table 4 illustrates a number of exemplary TDFs in a TDF bank used by an ATG in accordance with an embodiment of the present invention.

Table 5 illustrates exemplary TDF combinations and the resulting test parameters applied to a method under test in accordance with an embodiment of the present invention.

Table 6 illustrates an exemplary TDF Map (TDFM) in accordance with an embodiment of the present invention.

Table 7 illustrates a number of exemplary TDCs in accordance with an embodiment of the present invention.

Table 8 illustrates two exemplary TDDs in accordance with an embodiment of the present invention.

Table 9 illustrates two exemplary TDRs in accordance with an embodiment of the present invention.

Table 10 illustrates an exemplary TDFM for a method PhoneBook.addEntry in accordance with an embodiment of the present invention.

Table 11 illustrates an exemplary TDFM for a method WebPageReader.parsePage in accordance with an embodiment of the present invention.

Table 12 illustrates an exemplary TDFM for a method XMLParser.parse in accordance with an embodiment of the present invention.

Table 13 illustrates an exemplary of combined TDFM for parameters of type String in accordance with an embodiment of the present invention.

Table 14 illustrates an exemplary TDR in accordance with an embodiment of the present invention.

Table 15 illustrates an exemplary set of predicates in accordance with an embodiment of the present invention.

Table 16 illustrates an exemplary piece of CUT.

Table 17 illustrates a number of exemplary predicates that can be extracted from the CUT in Table 16 in accordance with an embodiment of the present invention.

Table 18 illustrates an exemplary CUT-specific TDR in accordance with an embodiment of the present invention.

Table 19 illustrates the format of a TDR in accordance with an embodiment of the present invention.

Table 20 illustrates three exemplary TDRs from which GTDRs can be derived in accordance with an embodiment of the present invention.

Table 21 illustrates exemplary predicate-to-TDD correlations in accordance with an embodiment of the present invention.

Table 22 illustrates three exemplary GTDRs derived based on predicate-TDD correlations in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Test Data Factories

A test data factory (TDF) is a software object that generates test data objects. Test data objects are instances of basic data types, or other software objects, which may be used as input data in the testing of a software system. TDFs are a way for software developer and testers to archive, reuse, and share their knowledge and efforts related to the creation and/or selection of test data.

In an embodiment of this invention, a TDF may implement the following functions:
A method that returns the type of the test data object(s) that it generates.
A method that returns the number of unique instances of test data object generated by the TDF.
A method that returns a unique identifier (ID) for the TDF itself.
A method that returns an instance of a test data object of the desired type upon each invocation.

The following examples use Java syntax to show exemplary implementation and usage of TDFs. Note that the basic ideas and principles described here can be implemented in, and applied to, other programming languages and systems. In Java, one can describe a TDF by creating an interface for it, as shown in Table 1.

TABLE 1

```
public interface TDF {
  public String getDataType( );
  public int getNumUniqueInstances( );
  public String getID( );
  public Object getInstance( );
}
```

A TDF ideally implements the above-described TDF interface. The example in Table 2 shows a simple TDF that produces an empty String.

TABLE 2

```
public class EmptyStringTDF implements TDF {
  public String getDataType( ) {
    return “java.lang.String”;
  }
  public int getNumUniqueInstances( ) {
    return 1;
  }
  public String getID( ) {
    return getClass( ).getName( );
  }
  public Object getInstance( ) {
    return “”;
  }
}
```

This particular example uses the TDF class name as the unique ID. One may also create unique IDs in different ways. The following slightly more complex example in Table 3 shows a TDF that generates String objects representing various formats of phone numbers.

TABLE 3

```
public class PhoneNumberStringsTDF implements TDF {
  String[ ] numbers;
  int index;
  public PhoneNumberStringsTDF( ) {
    numbers = new String[5];
    numbers[0] = “555-1212”;
    numbers[1] = “(650) 555-1212”;
    numbers[2] = “650.555.1212”;
    numbers[3] = “1 (650) 555-1212”;
    numbers[4] = “+1 (650) 555-1212 xt336”;
    index = 0;
  }
  public String getDataType( ) {
    return “java.lang.String”;
  }
  public int getNumUniqueInstances( ) {
    return numbers.length;
  }
  public String getID( ) {
    return getClass( ).getName( );
  }
  public Object getInstance( ) {
    if (index == numbers.length)
    index = 0;
    return numbers[index++];
  }
}
```

These two example illustrate that TDFs provide more than just usable objects of the right type to be used as test data. A TDF contains human knowledge and insight about what constitutes good and relevant test data for a particular data type. The test data a developer/tester created and made available through that TDF is useful and relevant to not only to that developer/tester, but also to other developers/testers working on other applications that use the same data type. TDFs make it possible to reuse the programming effort made to create the TDFs and, hence, make software testing more effective and efficient.

The following examples use objects of type “java.lang.String” (“String” for short) and other basic data types for clarity purposes. However, a TDF may construct objects of any type and complexity because there are no limitation on the size and scope of the code that can be added to the basic TDF interface. For instance, the last TDF example uses an additional constructor method “PhoneNumberStringTDF( )” to create an array with a list of pre-fabricated numbers.

Automatic Type Association of TDFs

TDFs are designed primarily for usage in automated test generators (ATG). One way for an ATG to generate software tests is to use TDFs that match the required test data types.

In the following example, an ATG is to find test data to test the method: PhoneBook.addEntry (String name, String phoneNumber). In addition, assume that the TDF bank used by the ATG includes the following TDFs of type String as shown in Table 4 (the number in parenthesis indicates the number of unique instances of test data objects that can be created by each TDF):

TABLE 4

NullTDF (1)
EmptyStringTDF (1)
MiscStringsForTesting (20)
NonASCIIStringsTDF (10)
PhoneNumberStringsTDF (5)
URLStringTDF (3)
NameStringsTDF (4)
StockSymbolStringsTDF (2)
USStatesStringsTDF (50)
FileNamesTDF (2)

This set of TDFs can produce 98 unique test data objects of type String. By combining test data objects created by these TDFs, the ATG can invoke the method PhoneBook.addEntry with almost 10,000 combinations for the two String parameters. Table 5 shows some of these TDF combinations and the resulting test parameters applied to the method under test.

TABLE 5

| | TDF for name | TDF for | Resulting method |
|---|---|---|---|
| Case # | parameter | phone parameter | invocation |
| 1 | EmptyStringTDF | URLStringTDF | addEntry(“”, “http:// |
| | | | www.agitar.com”) |
| 2 | StockSymbolTDF | USStatesInitialsTDF | addEntry(“IBM”, “CA”) |
| 3 | NameStringsTDF | NullTDF | addEntry(“John Doe”, null) |
| 4 | NameStringTDF | PhoneNumberStringTDF | addEntry(“Jane |
| | | | Doe Ph.D”, “650.555.1212”) |
| 5 | URLStringTDF | EmptyStringTDF | addEntry(“http:// |
| | | | www.abc.com/index. html”, “”“) |
| 6 | USStatesStringsTDF | FileNamesTDF | addEntry(“New |
| | | | Hampshire”, “C:/ |
| | | | AUTOEXEC.BAT”) |
| . | . | . | . |
| . | . | . | . |
| . | . | . | . |

As Table 5 shows, out of the method invocations listed in the example, only one (case # 4) receives realistic test data (i.e., a string that resembles a name for the name parameter, and a string that resembles a phone number in the phoneNumber parameter). Some of the other test cases, however, are still relevant since they use String type TDFs that are particularly important for testing String parameters. Case #1, for example, is a good test of what would happen when the name parameter is empty. Case #3 is also a good test of what would happen when the phone number parameter is null. Other test cases appear to be irrelevant (cases #2 and #6 for example). A few of these extreme cases are good for checking error handling, but a large number of nonsensical test inputs add little testing value, and may consume precious test execution and results analysis time which could be spent on more realistic and relevant test data (e.g., ensuring that the method correctly accepts and processes all possible variations of a phone number).

In general, the most commonly used data types are likely to have a large number of pre-existing matching TDFs. The ubiquitous String data type, for example, can be used to represent anything from the abbreviation of a US State name, to a social security number, to the HTML content of a Web page, to the entire text of Shakespeare's work. A method designed to parse Web page content, for example, should be tested with a wide range of test data strings representing valid and invalid HTML content. Testing it with String parameters that represent the 50 US States is of little value.

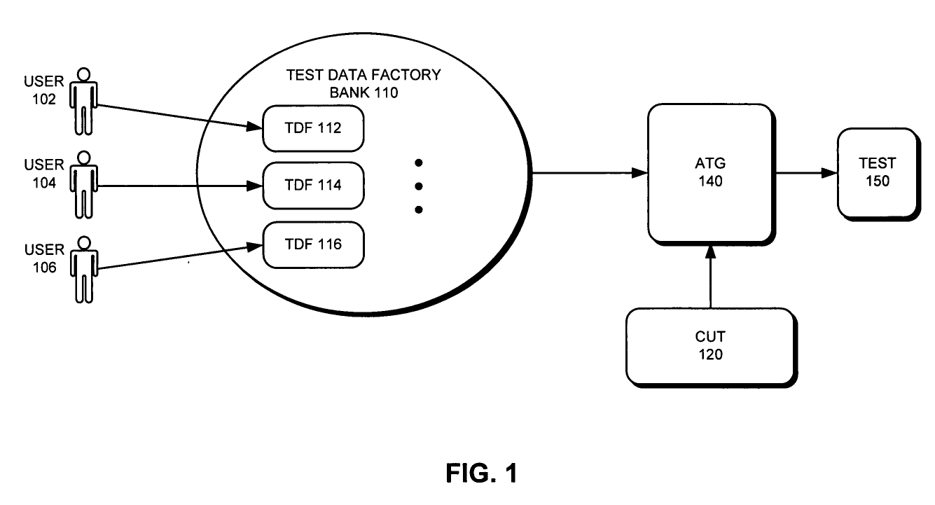

FIG. 1 illustrates automatic type association between a piece of code under test and the test data factories in an automated test generator in accordance with an embodiment of the present invention. As is shown in FIG. 1, a TDF bank 110 contains a number of TDFs, such as TDFs 112, 114, and 116, which are contributed by users 102, 104, and 106, respectively. When a piece of code under test (CUT) 220 is presented to ATG 240, ATG 240 inspects the type of the parameters of CUT 220, and select a number of TDFs from TDF bank 110 with matching test data types. Based on these selected TDFs, ATG then generates a test 150 for CUT 220. Such automatic type association, as illustrated in the previous example for method PhoneBook.addEntry, may create a large amount of irrelevant test data.

Manual Association of TDFs Using a TDF Map

Although an ATG can automatically assign TDFs based on data types, a non-discriminatory and all-inclusive approach to the problem can often create an excess of nonsensical and redundant test data. One approach to filtering excessive TDFs is to present all the available choices to the user (the developer/tester) and to have them use their knowledge of the code under test and of the general domain to the application to decide which TDFs to use.

In this manual association approach, the ATG presents to the user (e.g., via a graphical user interface) all the applicable TDFs for each parameter. The user then selects (e.g., by clicking on a selection button) which TDFs to associate with each parameter. This creates a TDF mapping (TDFM) between each parameter and the desired TDFs. The ATG stores this TDFM and uses it when it needs to generate and apply test data on the following, and subsequent test runs.

TABLE 6
Test Data Factory Map for:
Class: PhoneBook
Method: addEntry (String name, String phoneNumber)
Parameter: String phoneNumber

| TDF ID | Use TDF? |
|---|---|
| nullTDF (1) | X |
| EmptyStringTDF (1) | X |
| MiscStringsForTestingTDF (20) | X |
| NonASCIIStringTDF (10) | |
| PhoneNumberStringTDF (5) | X |
| URLStringTDF (3) | |
| NameStringsTDF (4) | |
| StockSymbolStringsTDF (2) | |
| USStatesStringsTDF (50) | |
| FileNamesTDF (2) | |

Table 6 illustrates an example TDFM in accordance with an embodiment of the present invention. Through this TDFM, the user communicates to the ATG that for the String parameter phoneNumber, it should use the emptyStringTDF, nullTDF, MiscStringsForTestingTDF, and PhoneNumberStringsTDF, and not to bother with other types of Strings such as URLs or stock symbols, as test inputs. This reduces the number of candidate test data objects for this parameter from 98 to 27. When the results of such filtering are combined with a similar filtering on the name parameter, the number of test-input combinations decreases from almost 10,000 to a few hundred. Furthermore, those few hundred cases will be more focused on realistic and relevant inputs.

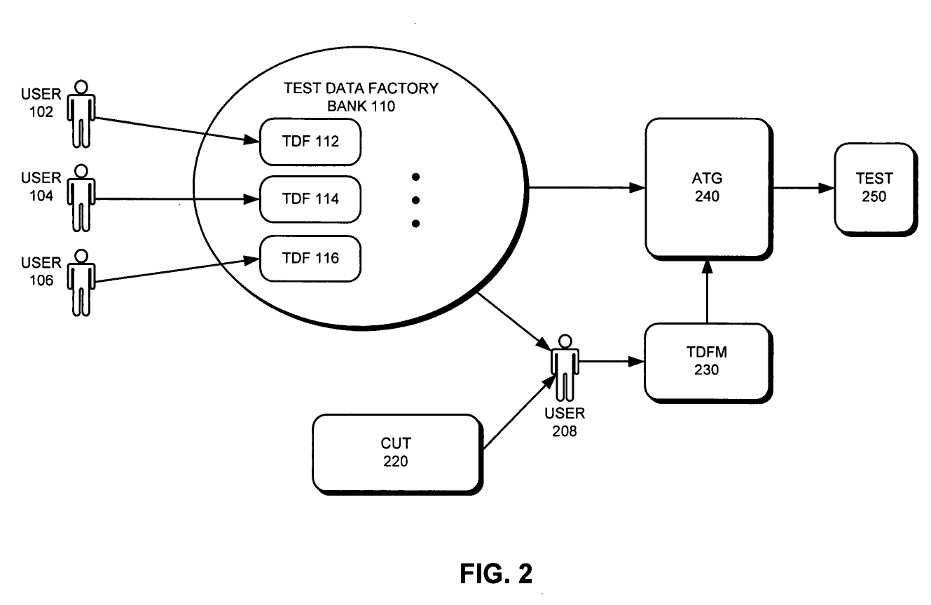

FIG. 2 illustrates manual association between a piece of code under test and the test data factories in an automated test generator using a TDF map in accordance with an embodiment of the present invention. As is shown in FIG. 2, user 208 selects a number of TDFs from TDF bank 110 based on CUT 220. Accordingly, the selected TDFs and CUT 220 result in TDFM 230, which is received and stored by ATG 240. Based on TDFM 230 and TDF bank 110, ATG 240 then produces an appropriate test 250 for CUT 220. Note that an automatic type association process can be used to pre-filter the TDFs to be presented to user 208.

Since a TDFM encapsulates human understanding and knowledge about relevant test data for a particular situation, it would be very desirable to reuse that knowledge when the ATG encounters a similar test situation. The goal is to help the ATG make better TDF selections even in the absence of user input or, at least, present to the user a smaller, pre-filtered set of applicable TDFs. To make this possible, this invention introduces the concept of test data rules and a mechanism for automatically generating test data rules from a set of TDFMs.

Test Data Rules

TDFs are a mechanism for generating and storing relevant test data objects for a particular data type and for making the test data objects readily available for reuse and sharing. Similarly, Test Data Rules (TDRs) are a mechanism for storing, sharing, and applying insight and knowledge about the most suitable TDF. A TDR includes a test data condition (TDC) and one or more test data directives (TDDs) associated with the TDC.

A TDC is a Boolean expression that describes a specific testing situation. The following are examples of TDCs:
The type of the parameter is java.lang.String.
The parameter name is phoneNumber.
The parameter is of type java.lang.String, the parameter name starts with “file” or “File,” and the parameter is used in an invocation of the method java.io.FileReader (String).
The method name is “readFile” and it has a parameter of type java.lang.String.

Without loss of generality, these TDCs can be expressed with an object oriented syntax based on the Java programming language as shown in Table 7.

TABLE 7

param.type.equals(“java.lang.String”)
param.name.equals(“phoneNumber”)
param.type.equals(“java.lang.String”)
&&
( param.name.startsWith(“file”) ||
param.name.startsWith(“File”) )
&&
param.isUsedBy(“java.io.FileReader(String) ”)
param.method.name.equals(“readFile”)
&&
param.type.equals(“java.lang.String”)

In the examples above, the object param represents a parameter in a method under test. The type of the parameter is represented by param.type, which returns a Java String. The name of the parameter is represented by param.name, which also returns a Java String. The Boolean methods param.isUsedBy (String methodSignture) and param.isUsedBy (String methodSignature, int argumentIndex) return true if the method under test uses the parameter as one of its arguments. The first form is used if the invoked method has only one argument. If the invoked method has multiple parameters, argumentIndex is used to indicate the position of the parameter in the method invocation.

A TDD specifies which TDFs to use by invoking the method param.useTDF(TDF tdf). This method instructs the ATG to use the specified TDF to generate input values for the parameter param. Table 8 shows some examples of TDDs.

TABLE 8

| | |
|---|---|
| Sample TDD 1 | param.useTDF (EmptyStringTDF) |
| Sample TDD 2 | param.useTDF (NullTDF) |
| | param.useTDF (EmptyStringTDF) |
| | param.useTDF (PhoneNumberStringsTDF) |

Test data directives can be made more efficient and/or effective by being more precise or specific about the TDF usage. One could, for example, add a directive that instructs the ATG to only pick one of all the possible values for a TDF (e.g., param.useTDFOnce (String tdf)), or to specify a minimum or maximum number of test data instances from that TDF (e.g., param.useTDFAtLeast (String tdf, int minInstances)). One may even instruct the ATG not to use data from a particular TDF (e.g., param.dontUseTDF (String tdf)) if the TDF might cause problems (e.g., using the name of system files as parameters to a method that deletes files).

A TDR is constructed by combining a TDC and TDDs in the following format: if (TDC) {TDD(s)}.

Table 9 shows some examples of TDRs.

TABLE 9

| | |
|---|---|
| TDR Example 1 | if (param.type.equals (“java.lang.String”)) { |
| | param.useTDF (EmptyStringTDF); |
| | } |
| TDR Example 2 | if ( param.type.equals (“java.lang.String”) && |
| | param.isUsedBy(java.io.FileReader (String)) { |
| | param.useTDF (TemporaryTestFileNamesTDF); |
| | param.useTDF (MiscFileNamesStringsTDF); |
| | param.useTDF (NonExistingFileNamesTDF); |
| | } |

TDR Example 1 directs the ATG to use TDF EmptyStringTDF when dealing with parameters of type String. This TDR encapsulates the testing knowledge that one should ensure that the method under test can handle an empty string.

TDR Example 2 embodies the testing knowledge that if a parameter of type String is used by the method FileReader, the code under test most probably expects that parameter to be the name of an existing file and the ATG should use TDFs that produce file names. The three directives issued by the TDR ensure that the test data for the parameter includes an assortment of file names representing both existing and non-existing files.

Automated Generation of TDRs from TDFMs

Test Data Rules and Test Data Factory Maps both encapsulate and store valuable human knowledge and insight about the selection and application of test data from TDFs. But there is a fundamental difference between the two. TDRs are designed to be generally applicable. The knowledge contained in a TDR is of the form: whenever these test data conditions are met, use these TDFs. In contrast, TDFMs contain information that is very specific to the particular method and parameter under test. The knowledge contained in a TDFM is of the form: for this parameter in this method, in this class, and in this package, use these TDFs in this way.

Since TDRs are generally applicable and since the knowledge they embed can be shared and reused for other tests, they are more desirable than TDFMs. Hence, it is desirable to automatically generate TDRs from TDFMs.

The first step in creating generally applicable TDRs from method- and parameter-specific TDFMs, is to identify commonalities between sets of TDFMs. Assume there are three TDFMs as shown in Table 10, Table 11 and Table 12, all of which are for a parameter of type String. In the first TDFM the string represents a phone number in a PhoneBook class, in the second TDFM it represents a URL in a WebPageReader class, and in the third TDFM the string represents the name of an XML file for an XMLParser class.

TABLE 10
Test Data Factory Map for:
Class: PhoneBook
Method: addEntry (String name, String phoneNumber)
Parameter: String phoneNumber

| TDF ID | Use TDF? |
|---|---|
| nullTDF (1) | X |
| EmptyStringTDF (1) | X |
| MiscStringsForTestingTDF (20) | X |
| NonASCIIStringTDF (10) | |
| PhoneNumberStringTDF (5) | X |
| URLStringTDF (3) | |
| NameStringsTDF (4) | |
| StockSymbolStringsTDF (2) | |
| USStatesStringsTDF (50) | |
| FileNamesTDF (2) | |

TABLE 11
Test Data Factory Map for:
Class: WebPageReader
Method: parsePage (String url)
Parameter: String url

| TDF ID | Use TDF? |
|---|---|
| nullTDF (1) | X |
| EmptyStringTDF (1) | X |
| MiscStringsForTestingTDF (20) | X |
| NonASCIIStringTDF (10) | |
| PhoneNumberStringTDF (5) | |
| URLStringTDF (3) | X |
| NameStringsTDF (4) | |
| StockSymbolStringsTDF (2) | |
| USStatesStringsTDF (50) | |
| FileNamesTDF (2) | |

TABLE 12
Test Data Map for:
Class: XMLParser
Method: parse (String xmlFile)
Parameter: String xmlFile

| TDF ID | Use TDF? |
|---|---|
| nullTDF (1) | X |
| MiscStringsForTestingTDF (20) | X |
| NonASCIIStringTDF (10) | X |
| PhoneNumberStringTDF (5) | |
| URLStringTDF (3) | |
| NameStringsTDF (4) | |
| StockSymbolStringsTDF (2) | |
| USStatesStringsTDF (50) | |
| FileNamesTDF (2) | X |

The three parameters in question do not have much in common other than their type (i.e., String). However, if the TDF selection from the three TDFMs are combined, there appears to be a pattern, as shown in Table 13.

TABLE 13
Combined TDFM for Parameters of Type String

| TDF ID | Use TDF? |
|---|---|
| nullTDF (1) | XXX |
| EmptyStringTDF (1) | XXX |
| MiscStringsForTestingTDF (20) | XX |
| NonASCIIStringTDF (10) | X |
| PhoneNumberStringTDF (5) | X |
| URLStringTDF (3) | X |
| NameStringsTDF (4) | |
| StockSymbolStringsTDF (2) | |
| USStatesStringsTDF (50) | |
| FileNamesTDF (2) | X |

In all three cases, the user selected nullTDF and EmptyStringTDF. Hence it can be implied that these TDFs are more likely to be used for parameters of type String. In two out of three cases, MiscStringsForTestingTDF is selected, indicating that this TDF is also likely to be used for parameters of type String.

Given a sufficiently large number of samples, it can be assumed that if, for example, 60% or more of TDFMs that share the same TDC agree on using a specific TDF, it is an indication that this TDF is likely to be a good candidate to be used on other CUTs that satisfy the same TDC. Accordingly, a rule can be created, as shown in Table 14.

TABLE 14

```
if (param.type.equals(“java.lang.String”)) {
  param.useTDF(NullTDF);
  param.useTDF(EmptyStringTDF);
  param.useTDF(MiscStringsForTestingTDF);
}
```

Discovering and Generating TDRs from TDFMs

A TDFM can be expressed as a mapping from a tuple comprising a parameter and the CUT associated with that parameter, to a tuple comprising one or more TDDs for that parameter:

TDFM: <param, CUT>→<param, TDDs>

A TDR, on the other hand, can be seen as a mapping from a tuple comprising a parameter and a set of predicates (PREDs) about that parameter, to a tuple comprising one or more TDDs for that parameter:

TDR: <param, PREDs>→<param, TDDs>

The right side of the mapping is the same for both TDFM and TDR. In order to generate a TDR from one or more TDFMs, one needs to create a mapping from the CUT to a set of predicates:

<param, CUT>→<param, PREDs>

This can be accomplished by analyzing the CUT and extracting a set of predicates which describe the properties of the parameter and the CUT. These predicates become part of the test data condition. The type and number of predicates that can be extracted from the CUT depends what predicates are available for describing the properties of the code and the parameter.

Table 15 shows an exemplary set of such predicates:

TABLE 15

param.type.equals (String aDataType)
param.name.equals (String aParameterName)
param.isUsedBy (String methodSignature)
.
.
.
param.belongsToMethod (String methodName)
param.belongsToClass (String className)
param.belongsToPackage (String packageName)
.
.
.
param.name.matches (String regularExpression)
param.methodName.matches (String regularExpression)
param.className.matches (String regularExpression)
param.packageName.matches (String regularExpression)
...

Assume that these predicates are applied to the following code sample shown in Table 16.

TABLE 16

```
package com.abc.phonebook
...
public class PhoneBook {
  ...
  HashMap phonelist;
  public PhoneBook( ) {
    phonelist = new HashMap( );
  }
  public void addEntry(String name, String phoneNumber) {
    phonelist.put(name, number);
  }
  ...
}
```

For the method addEntry and the parameter number the following predicates can be extracted, as shown in Table 17:

TABLE 17

param.name.equals(“phoneNumber”)
param.type.equals(“java.lang.String”)
param.isUsedBy(“HashMap.put(Object o)”)
param.belongsToMethod(“addEntry(String name, String number)”)
param.belongsToClass(“phonebook.PhoneBook”)
param.belongsToPackage(“phonebook”)
param.name.matches(“.*phone.*”)
param.className.matches(“.*phone.*”)
param.packageName.matches(“.*phone.*”)

The meaning of the first six predicates is self-explanatory. The last three predicates combine available predicates with some pre-existing regular expressions. These pre-existing regular expressions are designed to search matches in the package, class, or method name to give the ATG further clues about the nature and domain of the CUT. If there are TDFs that generate phone number strings, for example, the ATG may search string parameters with names such as “phone”, “phoneNumber”, “phoneNum”, etc., since it is likely that these parameters would match the corresponding TDFs.

Now that there are predicates for the TDC, these predicates can be combined with the TDFM for the same method. The result is the following TDR, shown in Table 18:

```
TABLE 18
if (
    param.name.equals(“phoneNumber”) &&
    param.type.equals(“java.lang.String”) &&
    param.isUsedBy(“HashMap.put(Object o)”) &&
    param.belongsToMethod(“addEntry(String name, String number)
”) &&
    param.belongsToClass(“phonebook.PhoneBook”) &&
    param.belongsToPackage(“phonebook”) &&
    param.name.matches(“.*phone.*”) &&
    param.className.matches(“.*phone.*”) &&
    param.packageName.matches(“.*phone.*”)
) {
    param.useTDF(“nullTDF”);
    param.useTDF(“EmptyStringTDF”);
    param.useTDF(“MiscStringsForTestingTDF”);
    param.useTDF(“PhoneNumberStringsTDF”);
}
```

Since the TDC for this TDR are derived from the CUT, this TDR will definitely be triggered by the parameter and CUT from which they were derived. Yet, unless there is another method with exactly the same name, and belong to a class and package with exactly the same name, it is unlikely that this rule will be reused because it is too specific.

If there is a collection of such rules (or TDFMs from which to automatically generate such rules), however, it is then possible to apply some statistical techniques for automatically generating much more general and applicable TDRs.

Generating Broadly Applicable TDRs from a Collection of Specific TDRs

If the predicates in a TDC are represented as p1, p2, . . . , pn, and the associated TDDs are represented as tdd1, tdd2, . . . , tddn, a typical TDR will have the form shown in Table 19:

TABLE 19

```
if ( p1 && p2 && ... && pn ) {
    tdd1;
    tdd2;
    ...
}
```

Assume that there is a collection of three distinct TDRs as shown in Table 20:

TABLE 20

| TDR1 | TDR2 | TDR3 |
|---|---|---|
| if ( p1 && p2 && p3 ) { | if ( p2 & p3 ) { | if ( p1 && p3 && p4 ) { |
| tdd1; | tdd1; | tdd1; |
| tdd2; | tdd2; | tdd4; |
| tdd3; | tdd4; | tdd6; |
| } | tdd5; | tdd7; |
| | } | } |

If one isolates the predicates in each TDC and creates a mapping from each individual predicate to the associated TDDs, one can compute the correlation between a predicate and every TDD as shown in Table 21.

TABLE 21

| Predicate | tdd1 | tdd2 | tdd3 | tdd4 | tdd5 | tdd6 | tdd7 |
|---|---|---|---|---|---|---|---|
| p1 | 100% | 50% | 50% | 50% | 0% | 50% | 50% |
| p2 | 100% | 100% | 50% | 50% | 50% | 0% | 0% |
| p3 | 100% | 67% | 33% | 67% | 33% | 33% | 33% |

| | |
|---|---|
| p4 | Insufficient samples |

A percentage X % at the intersection of a predicate and a TDD in Table 21 means that, based on all the TDFM-derived rules, there is an X % correlation between that predicate and the use of that TDD. This correlation can be used to automatically create a set of rules that can be generally applicable. An ATG could, for example, decide that a predicate to TDD correlation greater than 60% justifies the creation of a generalized TDR (GTDR). Based on the example correlations shown in Table 21, the following GTDRs can be generated, as shown in Table 22:

TABLE 22

if (p1) { tdd1; }
if (p2) { tdd1; tdd2; }
if (p3) { tdd1; tdd2; tdd4; }

The process described above allows a set of GTDRs to be extracted from a very specific set of TDFMs and/or TDRs (i.e., TDFMs and TDRs created for specific methods, classes, or applications). Such GTDRs can automatically applied by an ATG to similar methods, classes, and applications, leveraging the effort and knowledge invested in the original TDFs, TDFMs, and TDRs for the benefit of other users. Note that, as in the case of predicate p4 shown in Table 21, a minimum number of samples may be required for computing the correlation between a predicate and a TDD.

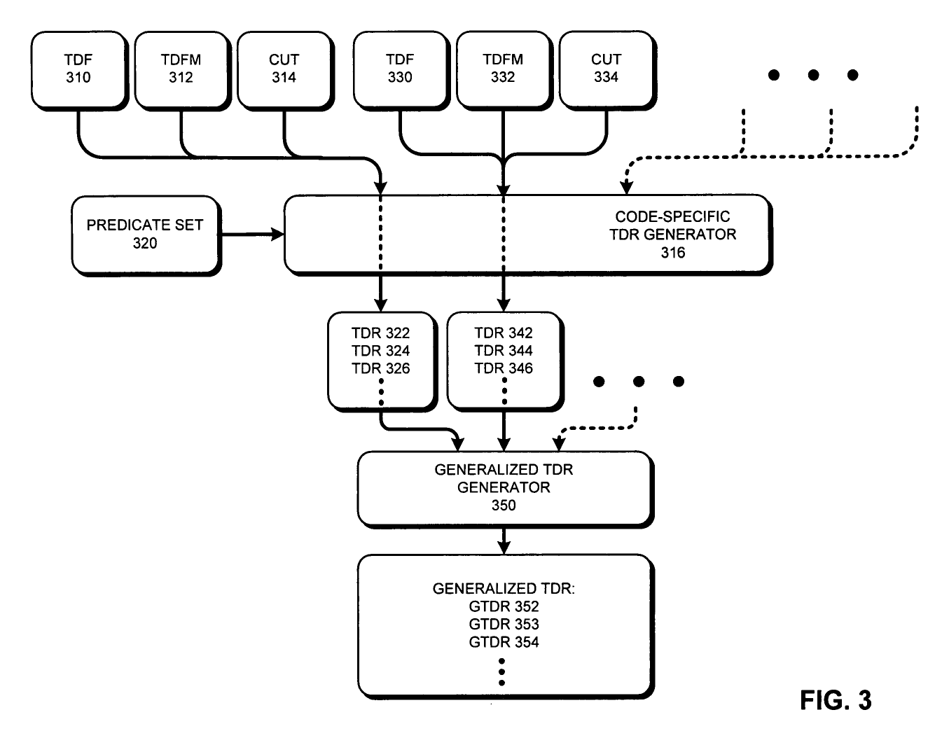

FIG. 3 presents a block diagram illustrating the process of producing generalized test data rules for automatic test data generation in accordance with an embodiment of the present invention. As is shown on the top left side of FIG. 3, TDF 310, TDFM 312, and CUT 314 are inputs to a code-specific TDR generator 316. Using a pre-determined predicate set 320, code-specific TDR generator 316 can produce a number of code-specific TDRs, such as TDRs 322, 324, and 326. However, TDRs 322, 324, and 326 are specific to CUT 314 and may not have a broad, general applicability. Similarly, code-specific TDR generator 316 extracts code-specific TDRs 342, 344, and 346 from TDF 330, TDFM 332, and CUT 334 based on predicate set 320. Note that, although FIG. 3 only shows two sets of TDF, TDFM, and CUT, code-specific TDR generator 316 may receive multiple sets of TDF, TDFM, and CUT to generate code-specific TDRs.

These code-specific TDRs are then processed by generalized TDR generator 350, which derives GTDRs based on the correlation between each predicate and available TDDs. The result is a set of GTDRs, such as GTDRs 352, 353, and 354, which can be used by the ATG to generate tests for other CUTs.

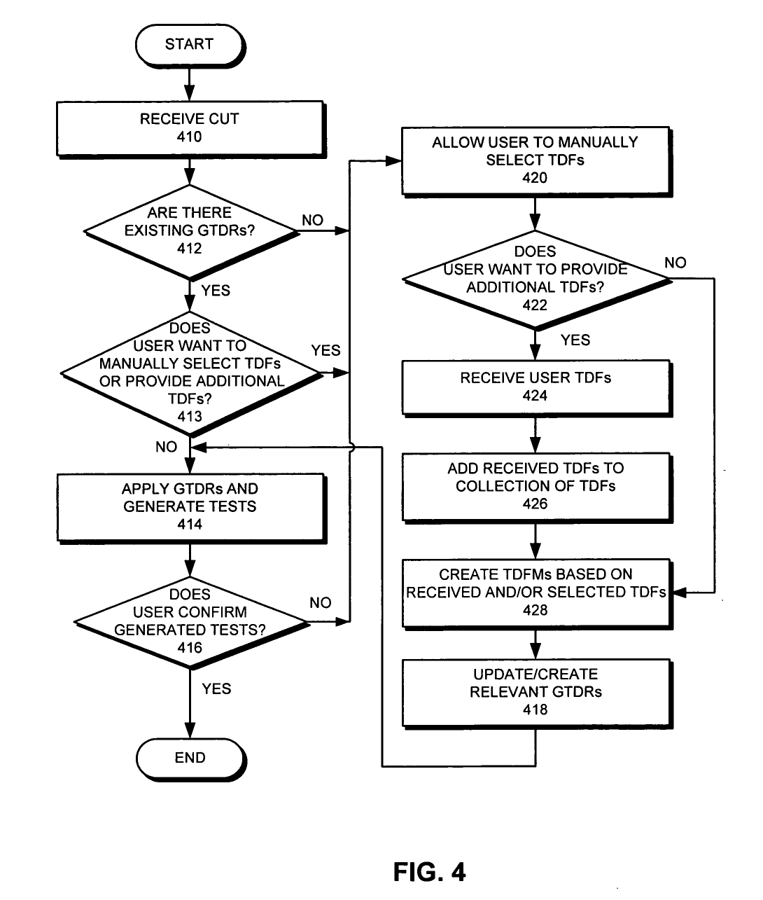

FIG. 4 presents a flow chart illustrating the process of automatically generating test data for a piece of code under test in accordance with an embodiment of the present invention. The system starts by receiving a piece of CUT (step 410). The system then determines whether there are any existing GTDRs that can be applied to the CUT (step 412). If there are no existing GTDRs, the system allows the user to manually select TDFs from a collection of TDFs (step 420). If there are existing GTDRs, the system further determines whether the user wants to manually select TDFs or to provide additional TDFs (step 413). If so, the system allows the user to manually select TDFs (step 420). Otherwise, the system applies these GTDRs and generates one or more tests for the CUT (step 414). Next, the system determines whether the generated tests are confirmed by the user (step 416). If the user confirms the generated tests, the test-generation process is complete. If not, the system allows the user to manually select TDFs or to provide additional TDFs (step 420).

After allowing the user to manually select TDFs, the system then determines whether the user wants to provide additional TDFs (step 422). If so, the system subsequently receives user-provided TDFs (step 424) and adds the received TDFs to the collection of TDFs (step 426). The system then creates TDFMs based on the user-provided and/or user-selected TDFs (step 428). If the user does not provide additional TDFs, the system directly creates TDFMs based on the user-selected TDFs (step 428). After creating TDFMs, the system then creates or updates relevant GTDRs which can be used for future CUT (step 418). Next, the system applies the GTDRs and generates one or more tests for the CUT (step 414). If the user confirms the generated tests (step 416), the process is complete.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. Additionally, the above disclosure is not intended to limit the invention. The scope of the invention is defined by the appended claims.

What is claimed is:

1. A method for automatically generating test data for code testing purposes, comprising:
receiving code under test (CUT);
determining type information for one or more parameters for methods of the CUT; and
automatically selecting, based on the type information, one or more test data factories (TDFs) to generate test data for parameters of the CUT.

2. The method of claim 1,
wherein automatically selecting one or more TDFs involves automatically selecting one or more test-data directives (TDDs); and
wherein a TDD may specify one or more TDFs to be used to generate test data and may specify the manner in which a TDF is used.

3. The method of claim 2, wherein automatically selecting the TDDs involves:
applying a number of generalized test data rules (GTDRs) to the CUT, wherein a GTDR specifies a test data condition (TDC) and specifies one or more TDDs to be used if the CUT satisfies the TDC, and wherein a TDC includes at least one predicate; and
if the CUT satisfies the TDC specified in a GTDR, automatically selecting the TDD(s) specified by the GTDR.

4. The method of claim 3, further comprising evaluating how frequently a TDD has been selected by a user to generate test data for CUT which satisfies a predicate; and
wherein if a TDD has been selected by a user sufficiently frequently to generate test data for CUT which satisfies a predicate, the method further comprises constructing a GTDR which includes the predicate in a TDC and which specifies the TDD.

5. The method of claim 4, wherein evaluating how frequently a TDD has been selected by a user to generate test data for CUT which satisfies a predicate involves computing a user-selection ratio for this predicate-TDD combination, which is the ratio of
the number of times a user has selected this TDD to generate test data for CUT which satisfies this predicate, to
the number of times CUT satisfies this predicate.

6. The method of claim 5, further comprising:
obtaining a new predicate from CUT, wherein one or more TDDs have been confirmed, selected, or provided by a user for this CUT; and
computing an updated user-selection ratio for a combination of this predicate and a TDD.

7. The method of claim 6, wherein obtaining the predicate from CUT involves applying one or more generic predicates without specific parameters to the CUT to obtain one or more predicates with specific parameters.

8. The method of claim 6, further comprising ranking GTDRs based on the user-selection ratio of the predicate-TDD combination included in each GTDR.

9. The method of claim 3, wherein if the user-selection ratio of a predicate-TDD combination falls below a given threshold, the method further comprises deleting a corresponding GTDR which includes this predicate and this TDD.

10. The method of claim 1, further comprising presenting the automatically selected TDFs to a user, and allowing the user to choose TDFs from the presented TDFs.

11. The method of claim 10, wherein presenting the automatically selected TDFs to the user involves presenting the TDFs on a host which is different from the host where the TDFs reside.

12. The method of claim 1, further comprising allowing a user to choose TDFs from a set of additional TDFs which are not automatically selected.

13. The method of claim 1, further comprising allowing a user to provide new TDDs and/or new TDFs.

14. The method of claim 13, wherein if the user provides one or more new TDDs and/or TDFs, the method further comprises storing the user-provided TDDs and/or TDFs so that these TDDs and/or TDFs may be used for future tests.

15. A computer-readable storage medium storing instructions that when executed by a computer cause the computer to perform a method for automatically generating test data for code testing purposes, the method comprising:
receiving CUT;
determining type information for one or more parameters for methods of the CUT; and
automatically selecting, based on the type information, one or more TDFs to generate test data for parameters of the CUT.

16. The computer-readable storage medium of claim 15,
wherein automatically selecting one or more TDFs involves automatically selecting one or more TDDs; and
wherein a TDD may specify one or more TDFs to be used to generate test data and may specify the manner in which a TDF is used.

17. The computer-readable storage medium of claim 16, wherein automatically selecting the TDDs involves:
applying a number of generalized test data rules (GTDRs) to the CUT, wherein a GTDR specifies a test data condition (TDC) and specifies one or more TDDs to be used if the CUT satisfies the TDC, and wherein a TDC includes at least one predicate; and
if the CUT satisfies the TDC specified in a GTDR, automatically selecting the TDD(s) specified by the GTDR.

18. The computer-readable storage medium of claim 17, wherein the method further comprises evaluating how frequently a TDD has been selected by a user to generate test data for CUT which satisfies a predicate; and
wherein if a TDD has been selected by a user sufficiently frequently to generate test data for CUT which satisfies a predicate, the method further comprises constructing a GTDR which includes the predicate in a TDC and which specifies the TDD.

19. The computer-readable storage medium of claim 18, wherein evaluating how frequently a TDD has been selected by a user to generate test data for CUT which satisfies a predicate involves computing a user-selection ratio for this predicate-TDD combination, which is the ratio of
the number of times a user has selected this TDD to generate test data for CUT which satisfies this predicate, to
the number of times CUT satisfies this predicate.

20. The computer-readable storage medium of claim 19, wherein the method further comprises:
obtaining a new predicate from CUT, wherein one or more TDDs have been confirmed, selected, or provided by a user for this CUT; and
computing an updated user-selection ratio for a combination of this predicate and a TDD.

21. The computer-readable storage medium of claim 20, wherein obtaining the predicate from CUT involves applying one or more generic predicates without specific parameters to the CUT to obtain one or more predicates with specific parameters.

22. The computer-readable storage medium of claim 20, wherein the method further comprises ranking GTDRs based on the user-selection ratio of the predicate-TDD combination included in each GTDR.

23. The computer-readable storage medium of claim 17, wherein if the user-selection ratio of a predicate-TDD combination falls below a given threshold, the method further comprises deleting a corresponding GTDR which includes this predicate and this TDD.

24. The computer-readable storage medium of claim 15, wherein the method further comprises presenting the automatically selected TDFs to a user, and allowing the user to choose TDFs from the presented TDFs.

25. The computer-readable storage medium of claim 24, wherein presenting the automatically selected TDFs to the user involves presenting the TDFs on a host which is different from the host where the TDFs reside.

26. The computer-readable storage medium of claim 15, wherein the method further comprises allowing a user to choose TDFs from a set of additional TDFs which are not automatically selected.

27. The computer-readable storage medium of claim 15, wherein the method further comprises allowing a user to provide new TDDs and/or new TDFs.

28. The computer-readable storage medium of claim 27, wherein if the user provides one or more new TDDs and/or TDFs, the method further comprises storing the user-provided TDDs and/or TDFs so that these TDDs and/or TDFs may be used for future tests.

29. An apparatus for automatically generating test data for code testing purposes, comprising:
a receiving mechanism configured to receive CUT; and
a selection mechanism configured to:
determine type information for one or more parameters for methods of the CUT; and
to automatically select, based on the type information, one or more TDFs to generate test data for parameters of the CUT.

30. The apparatus of claim 29,
wherein while automatically selecting one or more TDFs, the selection mechanism is configured to automatically select one or TDDs; and
wherein a TDD may specify one or more TDFs to be used to generate test data and may specify the manner in which a TDF is used.

31. The apparatus of claim 30, wherein while automatically selecting the TDDs, the selection mechanism is configured to:
apply a number of generalized GTDRs to the CUT, wherein a GTDR specifies a test data condition (TDC) and specifies one or more TDDs to be used if the CUT satisfies the TDC, and wherein a TDC includes at least one predicate; and
if the CUT satisfies the TDC specified in a GTDR, to automatically select the TDD(s) specified by the GTDR.

32. The apparatus of claim 31, wherein the selection mechanism is further configured to evaluate how frequently a TDD has been selected by a user to generate test data for CUT which satisfies a predicate; and
wherein if a TDD has been selected by a user sufficiently frequently to generate test data for CUT which satisfies a predicate, the selection mechanism is further configured to construct a GTDR which includes the predicate in a TDC and which specifies the TDD.

33. The apparatus of claim 32, wherein while evaluating how frequently a TDD has been selected by a user to generate test data for CUT which satisfies a predicate, the selection mechanism is configured to compute a user-selection ratio for this predicate-TDD combination, which is the ratio of
the number of times a user has selected this TDD to generate test data for CUT which satisfies this predicate, to
the number of times CUT satisfies this predicate.

34. The apparatus of claim 33, wherein the selection mechanism is further configured to:
obtain a new predicate from CUT, wherein one or more TDDs have been confirmed, selected, or provided by a user for this CUT; and
to compute an updated user-selection ratio for a combination of this predicate and a TDD.

35. The apparatus of claim 34, wherein while obtaining the predicate from CUT, the selection mechanism is configured to apply one or more generic predicates without specific parameters to the CUT to obtain one or more predicates with specific parameters.

36. The apparatus of claim 34, wherein the selection mechanism is further configured to rank GTDRs based on the user-selection ratio of the predicate-TDD combination included in each GTDR.

37. The apparatus of claim 31, wherein if the user-selection ratio of a predicate-TDD combination falls below a given threshold, the selection mechanism is further configured to delete a corresponding GTDR which includes this predicate and this TDD.

38. The apparatus of claim 29, further comprising a user interface configured to present the automatically selected TDFs to a user, and to allow the user to choose TDFs from the presented TDFs.

39. The apparatus of claim 38, wherein wile presenting the automatically selected TDFs to the user, the user interface is configured to present the TDFs on a host which is different from the host where the TDFs reside.

40. The apparatus of claim 29, further comprising a user interface configured to allow a user to choose TDFs from a set of additional TDFs which are not automatically selected.

41. The apparatus of claim 29, further comprising a user interface configured to allow a user to provide new TDDs and/or new TDFs.

42. The apparatus of claim 41, wherein if the user provides one or more new TDDs and/or TDFs, the apparatus further comprises a storage mechanism configured to store the user-provided TDDs and/or TDFs so that these TDDs and/or TDFs may be used for future tests.
